(19) United States
(12) Patent Application Publication
(10) Pub. No.: US 2013/0042051 A1
(43) Pub. Date: Feb. 14, 2013

(54) PROGRAM METHOD FOR A NON-VOLATILE MEMORY

(71) Applicants: HAN-LUNG HUANG, Hsinchu City (TW); Ming-Hung CHOU, Hsinchu City (TW)

(72) Inventors: HAN-LUNG HUANG, Hsinchu City (TW); Ming-Hung CHOU, Hsinchu City (TW)

(73) Assignee: SKYMEDI CORPORATION, Hsinchu City (TW)

(21) Appl. No.: 13/207,358

(22) Filed: Aug. 10, 2011

(51) Int. Cl. G06F 12/02

(52) U.S. Cl. 711/103; 711/E12.008

(57) ABSTRACT

A program method for a non-volatile memory is disclosed. At least two blocks in the non-volatile memory are configured as 1-bit per cell (1-bpc) blocks. The data of the configured blocks are read and written to a target block in such a way that the data of each said configured block are moved to pages of a same significant bit. In another embodiment, the data of the configured blocks excluding one block are read and written to the excluded block.

### BACKGROUND OF THE INVENTION

1. Field of the Invention

The present invention generally relates to a non-volatile memory, and more particularly to a program method for a non-volatile memory.

2. Description of Related Art

A flash memory is a non-volatile solid state memory device that can be electrically erased and reprogrammed. Conventional flash memory stores a single bit of information in each memory cell such that each memory cell can be programmed to assume two possible states. The conventional flash memory is thus commonly referred to as single-bit per cell flash memory. Modern flash memory is capable of storing two or more bits of information in each memory cell such that each memory cell can he programmed to assume more than two possible states. The modern flash memory is thus commonly referred to as multi-bit per cell flash memory.

FIG. 1 shows a conventional page program/read sequence in a block for a 3-bit per cell (3-bpc) flash memory, which performs page program/read in the following order:

00h→01h→02h→03h→04h→05h→06h→07h→BDh→BEh→BFh.

With the conventional page program/read sequence, pages of different significant bits need be continuously switched. Moreover, with respect to power failure while programming, for example, a most-significant-bit (MSB) page, the other page (e.g., a least-significant-bit (LSB) page) crashed on the same word line may probably be unrecoverable. Further, according to the conventional program/read sequence, adjacent word lines in the same block may have dramatically different writing intervals or writing temperature, and, therefore, retention loss or cell threshold voltage may be kept high. As a result, read-voltage adjustment scheme becomes complicated.

For the foregoing reasons, a need has thus arisen to propose a novel program method for the flash memory.

### SUMMARY OF THE INVENTION

In view of the foregoing, it is an object of the embodiment of the present invention to provide a program method for a non-volatile memory in order to improve cell threshold voltage and bit error rate, and further simplify read-voltage adjustment scheme.

According to one embodiment, at least two blocks in the non-volatile memory are configured as 1-bit per cell (1-bpc) blocks, in each of which only least-significant-bit (LSB) pages are used to store data. The data of the configured blocks are read and written to a target block of the non-volatile memory in such a way that the data of each said configured block are moved, to pages of a same significant bit.

According to another embodiment, at least one block in the non-volatile memory is configured as 1-bit per cell (1-bpc) blocks, wherein only least-significant-bit (LSB) pages of the configured block are used to store data. A target block having LSB pages stored with data is provided. The data of each configured block are read and written to the target block in such a way that the data of each said configured block are moved to pages of a same significant bit other than the LSB.

### BRIEF DESCRIPTION OF THE DRAWINGS

FIG. 1 shows a conventional page program/read sequence in a block for a 3-bpc flash memory;

FIG. 2A shows an exemplary schematic diagram illustrative of a program method according to a first embodiment of the present invention;

FIG. 2B shows a flow diagram associated with FIG. 2A;

FIG. 3 shows a modified first embodiment of FIGS. 2A/2B;

FIG. 4A shows a threshold voltage distribution on a word line of a 3-bpc flash memory without using the merge write technique;

FIG. 4B shows a threshold voltage distribution on a word line of a 3-bpc flash memory using the merge write technique;

FIG. 5A and FIG. 5B show an exemplary block and an associated re-programming scheme, respectively;

FIG. 6A and FIG. 6B show another exemplary block and an associated re-programming scheme, respectively;

FIG. 7A shows an exemplary schematic diagram illustrative of a program method according to a second embodiment of the present invention;

FIG. 7B shows a flow diagram associated with FIG. 7A; and

FIG. 8 shows a modified second embodiment of FIGS. 7A/7B.

### DETAILED DESCRIPTION OF THE INVENTION

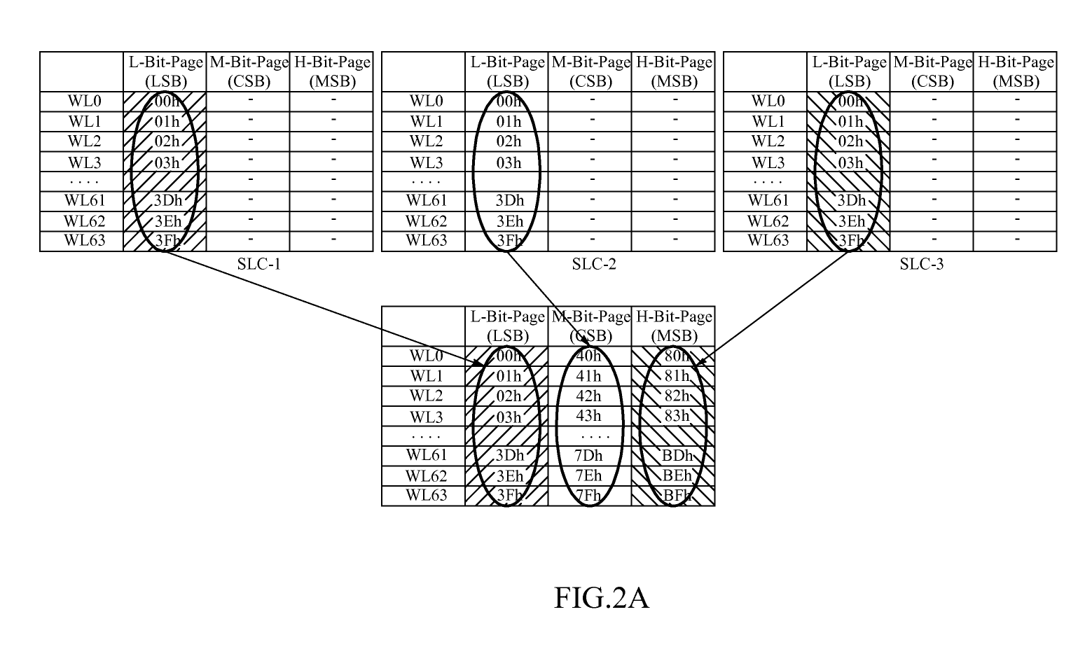

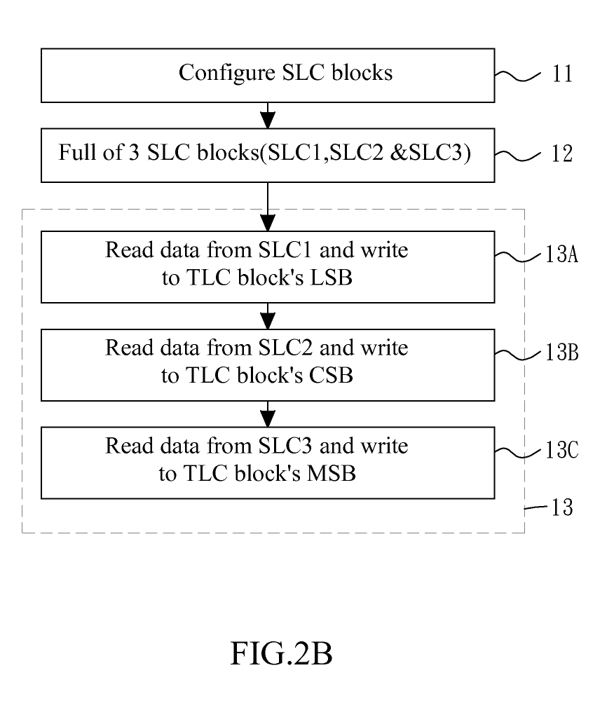

FIG. 2A shows an exemplary schematic diagram illustrative of a program method for a non-volatile memory according to a first embodiment of the present invention. FIG. 2B shows a flow diagram associated with FIG. 2A. Although a 3-bit per cell (3-bpc) flash memory is exemplified here, the present invention is adaptable to other type of multi-bit per cell flash memory (e.g., a 4-bit per cell (4-bpc) flash memory), or even adaptable to other non-volatile memory such as a phase change memory (PCM).

Referring to FIG. 2A and FIG. 2B, in step 11, some blocks (e.g., at least two blocks such as SLC-1, SLC-2 and SLC-3) in the flash memory are configured as 1-bit per cell (1-bpc) blocks. That is, only least-significant-bit (LSB) pages are used to store data, while center-significant-bit (CSB) pages and most-significant-bit (MSB) pages are unused. In this specification, the LSB page, the CSB page and MSB page are interchangeably called a low-bit-page, a mid-bit-page and a high-bit-page respectively; and the 1-bpc, the 2-bpc and 3-bpc may interchangeably be called SLC, MLC and TLC respectively. It is noted that the LSB pages generally have higher program/read efficiency and lower data error rate than the CSB pages or the MSB pages.

When at least two source 1-bpc blocks (e.g., blocks SLC-1, SLC-2 and. SLC-3) are full of data (step 12), the data of the 1-bpc blocks are read and written to a target block in such a way that the data of each source 1-bpc block are moved to pages of the same significant bit. (step 13). In other words, different 1-bpc block occupies pages of different significant bit. As exemplified in FIG. 2A, the data of the first 1-bpc block (e.g., the block SLC-1) are moved to LSB pages (step 13A), the data of the second 1-bpc block (e.g., the block SLC-2) are moved to CSB pages (step 13B), and the data of the third 1-bpc block (e.g., the block SLC-3) are moved to MSB pages (step 13C). It is noted that the program may be performed, in another embodiment, when at least one said source 1-bpc block is not full of data. In this case, the pages that have not been stored with data may each have a default value, like FFh (i.e., FF in hexadecimal).

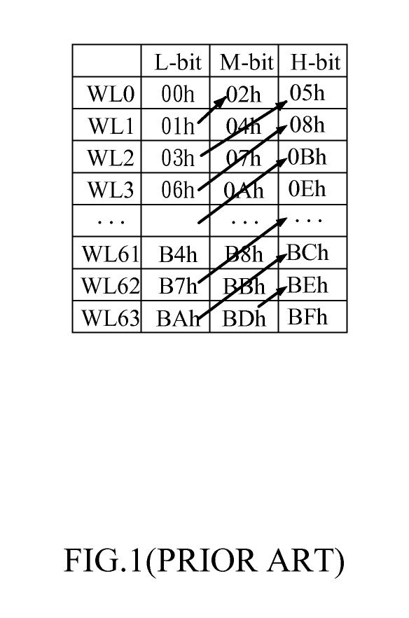

According to the program method demonstrated in FIG. 2A and FIG. 2B, as the whole block data can be moved in a short time e.g., 100 ms to 10 s), adjacent word lines in the same block may have similar writing intervals or writing temperature, and, therefore, retention loss or cell threshold voltage can be minimized between word lines and read-voltage adjustment scheme, if adopted, can be simplified and accelerated. Compared to the conventional read/program sequence as shown in FIG. 1, the program method of the embodiment using a novel sequence can prevent continuous switching of pages of different significant bits. Moreover, with respect to power failure during the program, as data still exist in the source 1-bpc block, data can therefore be recovered, thereby improving power cycle.

The operation of the program according to the embodiment described above (and other embodiments) may be performed in either of the following manners. Specifically speaking, the program may be carried, out according to a single block-program command, supported by the flash memory, issued to the flash memory from an external controller. The flash memory may internally perform the program after receiving the command. Therefore, no data need be read out of the flash memory, and no error-correcting-code (ECC) decoding is required. Alternatively, the controller may issue a command, for each page, to the flash memory, which accordingly performs program of the associated page. In an alternative scheme, the controller may issue a data movement command, such as a copy-back-program command, for internally perform the program without reading data out of the flash memory and without ECC decoding. In a further alternative scheme, the controller may read data out of the source 1-bpc blocks and then write the data to the flash memory to accomplish the program.

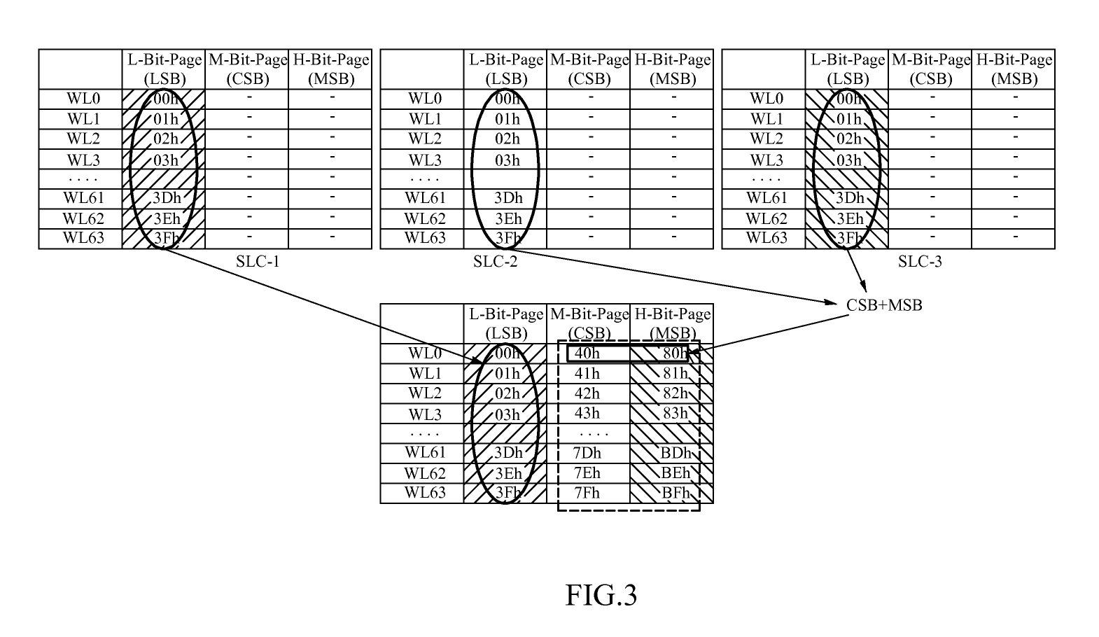

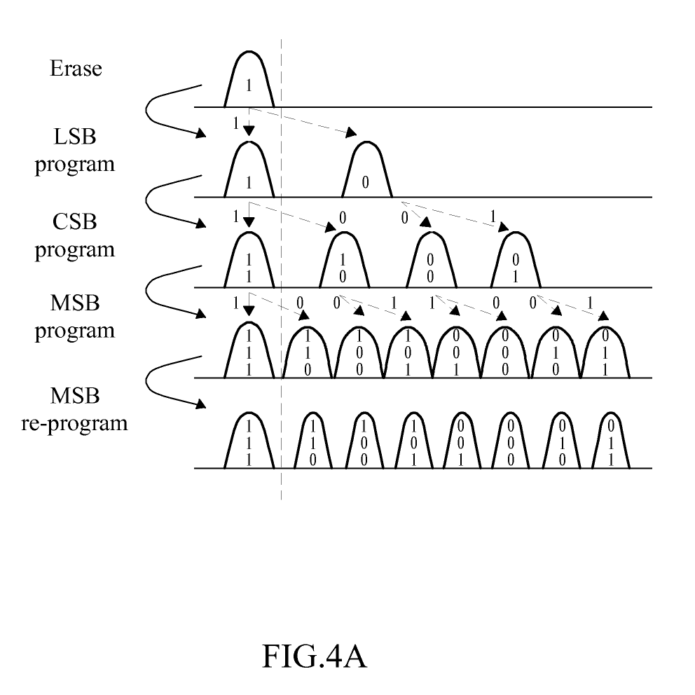

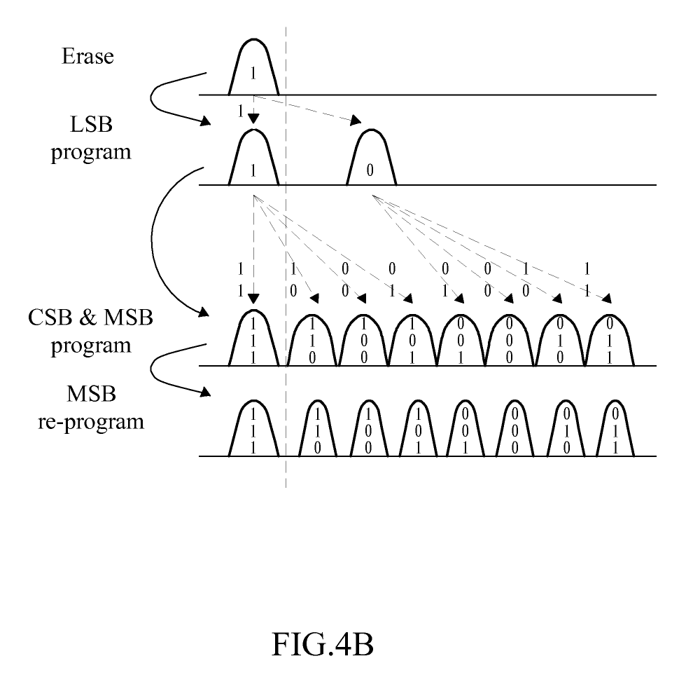

FIG. 3 shows a modified first embodiment of FIGS. 2A/2B. In the modified embodiment, some of the source 1-bpc blocks (e.g., the blocks SLC-2 and may be moved at the same time using a merge write technique. Specifically, as data of the source 1-bpc blocks (e.g., the blocks SLC-2 and SLC3) are available, they may be first combined and then moved to the CSB page and the MSB page of the target 3-bpc flash memory word line by word line. FIG. 4A shows a threshold voltage distribution on a word line of a 3-bpc flash memory without using the merge write technique, and FIG. 4B shows a threshold voltage distribution on a word line of a 3-bpc flash memory using the merge write technique. It may be observed from FIG. 4B that the CSB page and the MSB page of each given word line are programmed at the same time, instead of programming all the CSB pages before programming the MSB pages.

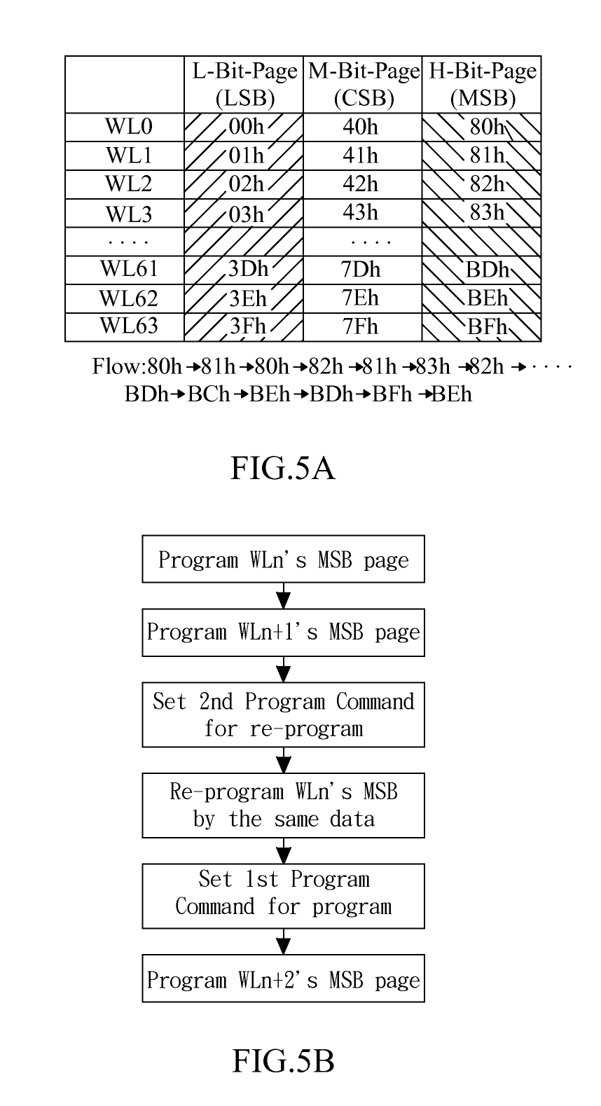

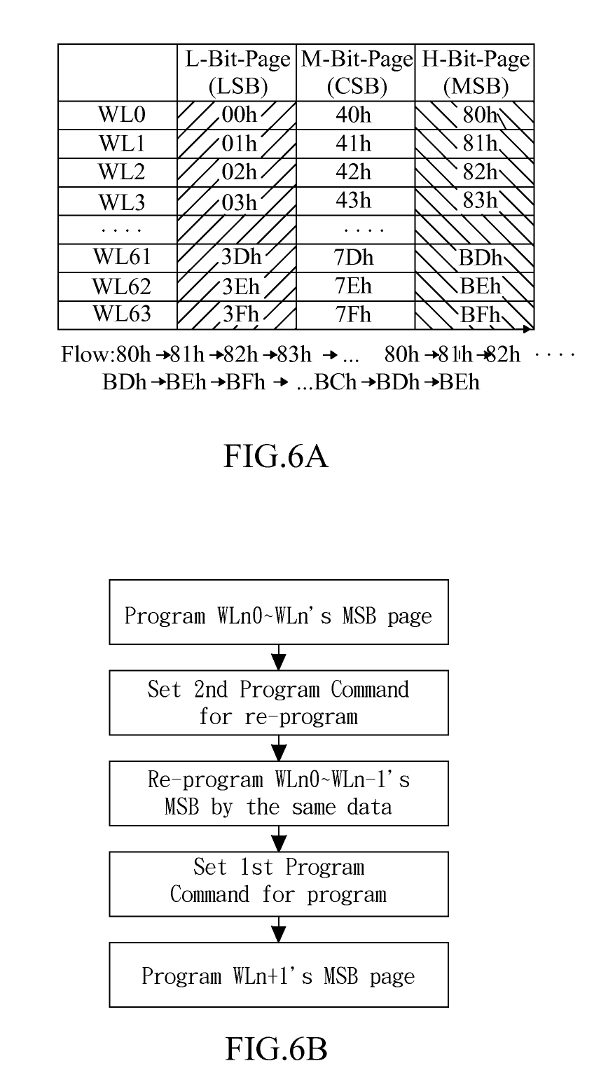

With respect to the program method discussed above, a re-programming (or twice-programming) technique may be further adopted to compensate for coupling effect and retention effect. The re-programming technique may be referred to co-pending U.S. application Ser. No. 12/831,612 filed on Jul. 7, 2010 and entitled “Method of Twice Programming a Non-Volatile Memory With a Sequence” assigned to the same assignee of the present application, and the disclosure of which is hereby incorporated herein by reference. FIG. 5A and FIG. 5B show an exemplary block and an associated re-programming scheme, respectively, according to which a programmed. MSB page on a current word line (e.g., WLn+1) is followed, by re-programming an MSB page on a word line e.g., WLn) preceding the current word line. In other words, the MSB pages are re-programmed on a word line basis. FIG. 6A and FIG. 6B show another exemplary block and an associated re-programming scheme, according to which the MSB pages on some word lines are programmed, followed by re-programming the MSB pages on at least a portion of said word lines (e.g., WL0-WLn−1). In other words, the MSB pages are re-programmed on a block basis.

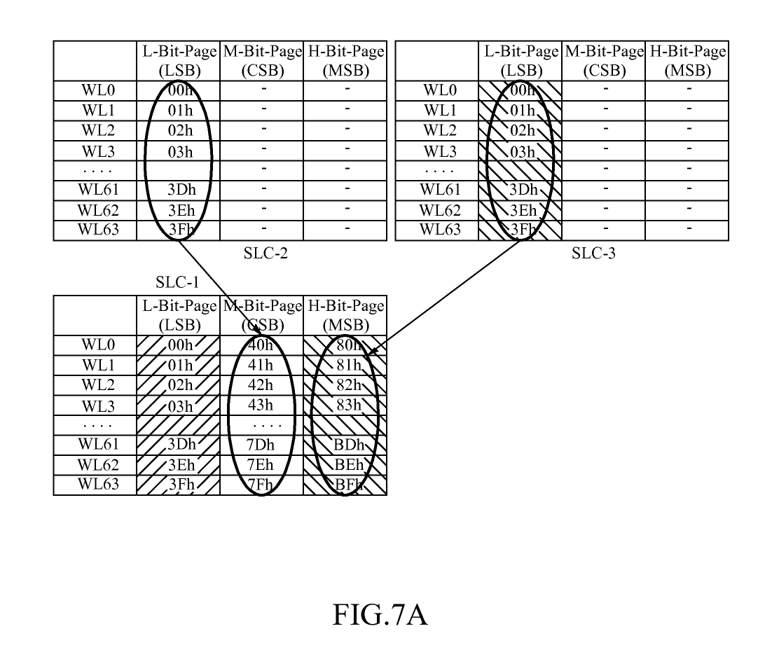

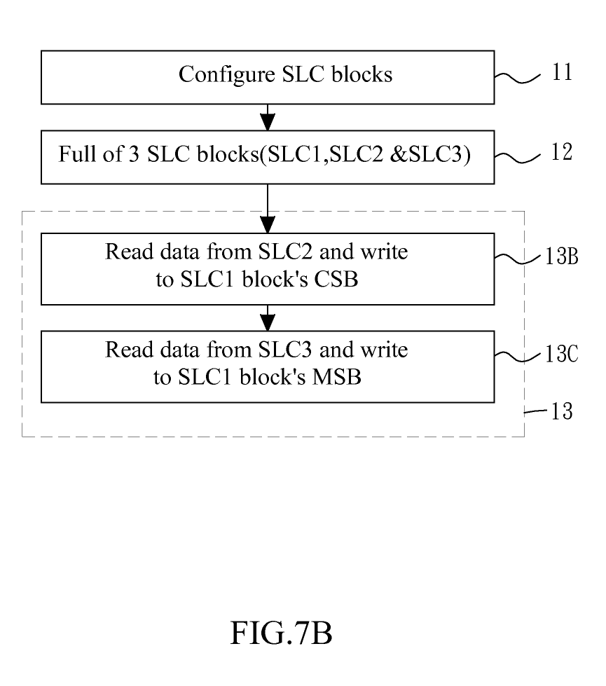

FIG. 7A shows an exemplary schematic diagram illustrative of a program method according to a second embodiment of the present invention. FIG. 7B shows a flow diagram associated with FIG. 7A. The second embodiment is similar to the first embodiment (FIGS. 2A/2B) except for the following distinctness. In the present embodiment, one 1-bpc block is provided as a target block having LSB pages stored with data, and the data of at least one 1-bpc block are read and written to the target block in such a way that the data of each source 1-bpc block are moved to pages of the same significant bit other than the LSB (step 13). In other words, different 1-bpc block occupies pages of different significant bit. As exemplified in FIG. 7A, the first 1-bpc block (e.g., the block SLC-1) is provided as the target block, and the data of the second 1-bpc block (e.g., the block SLC-2) are moved to CSB pages of the target block (step 13B), and the data of the third 1-bpc block (e.g., the block SLC-3) are moved to MSB pages of the target block (step 13C).

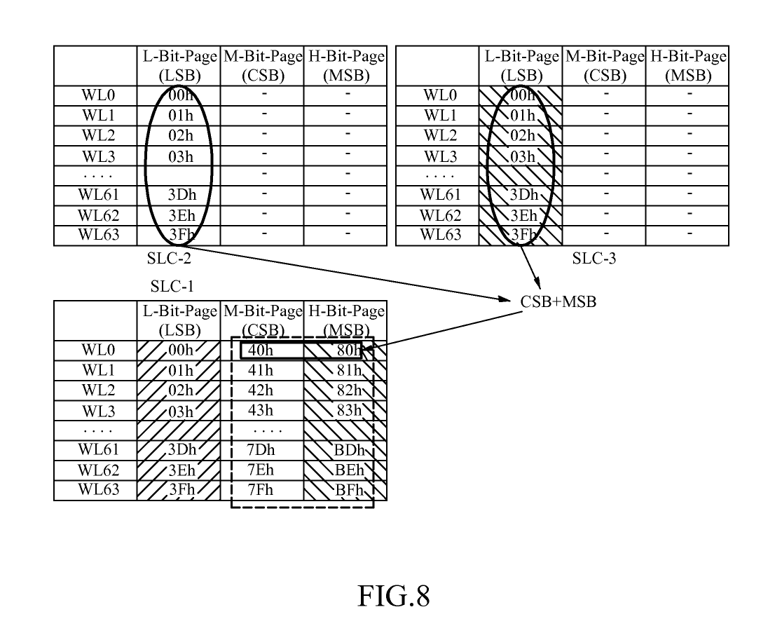

Similar to FIG. 3, the present embodiment may adopt the write merge technique as illustrated in FIG. 8, which shows a modified second embodiment of FIGS. 7A/7B. Furthermore, similar to FIGS. 5A/5B or FIGS. 6A/6B, the present embodiment may adopt the re-programming scheme to compensate for coupling effect and retention effect.

According to the embodiments described, above, as the program is performed by moving the LSB pages of an entire source block (no matter whether the source 1-bpc block is full or not), the cell threshold voltage will not be too low due to unwritten following word line, and, therefore, the bit error rate may be reduced.

Although specific embodiments have been illustrated and described, it will be appreciated by those skilled in the art that various modifications may be made without departing from the scope of the present invention, which is intended to be limited solely by the appended claims.

What is claimed is:

1. A program method for a non-volatile memory, comprising:
configuring at least two blocks in the non-volatile memory as 1-bit per cell (1-bpc) blocks, in each of which only least-significant-bit (LSB) pages are used to store data; and
reading and writing the data of the configured blocks to a target block of the non-volatile memory in such a way that the data of each said configured block are moved to pages of a same significant bit.

2. The method of claim 1, wherein the non-volatile memory is a multi-bit per cell flash memory.

3. The method of claim 2, wherein the flash memory is a 3-bit per cell (3-bpc) flash memory, and data of three said configured blocks are respectively moved to the LSB pages, center-significant-bit (CSB) pages and most-significant-bit (MSB) pages of the target block.

4. The method of claim 1, wherein at least one said 1-bpc block is full of data.

5. The method of claim 1, wherein at least two of the configured blocks are moved to the target block at the same time using a merge write technique, wherein data of the at least two configured blocks of each given word line are first combined, and are then programmed to the target block at the same time.

6. The method of claim 1, further comprising:
re-programming at least one most-significant-bit (MSB) page of the target block.

7. The method of claim 6, wherein the re-programming step comprises:
programming the MSB page on a current word line in the target block; and
re-programming the MSB page on a word line preceding the current word line.

8. The method of claim 6, wherein the re-programming step comprises:
programming the MSB pages on a plurality of word lines in the target block; and
re-programming the MSB pages on at least a portion of said plurality of word lines.

9. The method of claim 1, further comprising:
issuing a single block-program command to the non-volatile memory, wherein the non-volatile memory internally performs reading and writing the data of configured blocks to the target block according to the single block-program command.

10. The method of claim 1, further comprising:
issuing a copy-back-program command to the non-volatile memory, wherein the non-volatile memory internally performs reading and writing the data of configured blocks to the target block according to the copy-back-program command.

11. A program method for a non-volatile memory, comprising:
configuring at least one block in the nonvolatile memory as 1-bit per cell (1-bpc) block, wherein only least-significant-bit (LSB) pages of the configured block are used to store data;
providing a target block having LSB pages stored with data; and
reading and writing the data of each said configured block to the target block in such a way that the data of each said configured block are moved to pages of a same significant bit other than the LSB.

12. The method of claim 11, wherein the non-volatile memory is a multi-bit per cell flash memory.

13. The method of claim 12, wherein the flash memory is a 3-bit per cell (3-bpc) flash memory, and data of two said configured blocks are respectively moved to center-significant-bit (CSB) pages and most-significant-bit (MSB) pages of the target block.

14. The method of claim 11, wherein at least one said 1-bpc block is full of data.

15. The method of claim 11, wherein at least two of the configured blocks are moved to the target block at the same time using a merge write technique, wherein data of the at least two configured blocks of each given word line are first combined, and are then programmed to the target block at the same time.

16. The method of claim 11, further comprising:
reprogramming at least one most-significant-bit (MSB) page of the target block.

17. The method of claim 16, wherein the re-programming step comprises:
programming the MSB page on a current word line in the target block; and
re-programming the MSB page on a word line preceding the current word line.

18. The method of claim 16, wherein the re-programming step comprises:
programming the MSB pages on a plurality of word lines in the target block; and
re-programming the MSB pages on at least a portion of said plurality of word lines.

19. The method of claim 11, further comprising:
issuing a single block-program command to the non-volatile memory, wherein the non-volatile memory internally performs reading and writing the data of configured blocks to the target block according to the single block-program command.

20. The method of claim 11, further comprising:
issuing a copy-hack-program command to the non-volatile memory, wherein the non-volatile memory internally performs reading and writing the data of configured blocks to the target block according to the copy-back-program command.
